(19) United States
(12) Patent Application Publication
(10) Pub. No.: US 2006/0239499 A1
(43) Pub. Date: Oct. 26, 2006

(54) Semi-radially-charged conical magnet for electromagnetic transducer

(76) Inventor: Enrique M. Stiles, Imperial Beach, CA (US)

Correspondence Address: RICHARD C. CALDERWOOD, 2775 NW 126TH AVE, PORTLAND, OR, 97229-8381, US

(21) Appl. No.: 11/114,737

(22) Filed: Apr. 25, 2005

(51) Int. Cl. H04R 9/06

(52) U.S. Cl. 381/421

(57) ABSTRACT

An electromagnetic transducer such as an audio speaker, having a conical magnet, and an inner yoke and an outer yoke having conical surfaces for mating with the conical magnet. The conical magnet may be radially-charged, semi-radially-charged, or axially charged.

### BACKGROUND OF THE INVENTION

1. Technical Field of the Invention

This invention relates generally to electromagnetic transducers such as audio loudspeakers, and more specifically to a transducer motor structure having a conical magnet.

2. Background Art

Virtually all electromagnetic transducers use a “flat” motor structure, in which a ring or disc magnet is oriented with its flux emitting and receiving faces (north and south poles) oriented perpendicular to the axis of the motor (meaning that the surface extends in a plane which is perpendicular to the axis, and the axis is normal to the surface). With a given type of magnet, in order to increase the amount of magnetic flux in the magnetic circuit, it is far more effective to increase the size of the magnet by increasing its surface area than by increasing its thickness. Increasing its surface area usually increases the radius of the motor.

The surface area of a disc magnet is pi*r² and the surface area of an annular or ring magnet is pi*(rₒᵤₜₑᵣ²-rᵢₙₙₑᵣ²). Increasing the surface area of the magnet causes an increase in the radius of the motor that is fairly well approximated by the appropriate one of those formulas, with some variation to account for the non-magnet components which may not increase at the same rate.

An extremely few transducers have used a “cylindrical” motor structure, in which a radially-charged cylindrical magnet is disposed between a cylindrical inner yoke and a cylindrical outer yoke. With a given type of magnet, the amount of magnetic flux can be increased either by increasing the radius of the magnet, or by increasing the length of the magnet.

Unfortunately, because air is has very low magnetic conductivity (meaning that small air gaps have high magnetic reluctance), it is critical that the cylindrical magnet be in tight contact with both of the cylindrical yokes. Manufacturing tolerances make this difficult to achieve, especially with respect to the magnet, as the manufacturing tolerances of most types of magnets are harder to control than those of the steel yokes and other components. In addition, assembly of a radially-charged cylindrical magnet motor is very difficult and problematic.

What is needed is an improved motor geometry which offers improved magnetic flux scaling without a corresponding increase in motor diameter, and which offers improved manufacturability.

### BRIEF DESCRIPTION OF THE DRAWINGS

FIG. 1 shows a loudspeaker according to one embodiment of this invention.

FIG. 2 with detail view 2A shows a close-up view of the motor structure of the loudspeaker of FIG. 1.

FIGS. 3-5 show various stages of assembly of the motor structure of FIG. 2.

FIG. 6 shows a sectional view of the motor structure of FIG. 2.

FIG. 7 shows a dual magnetic air gap motor structure according to another embodiment of this invention.

FIG. 8 shows a motor structure having a radially charged conical magnet and a low reluctance return path according to another embodiment of this invention.

FIG. 9 shows a motor structure having a radially charged conical magnet which flares the opposite direction as previously illustrated embodiments.

FIG. 10 and detail views 10A and 10B show a double-ended, coaxial embodiment.

FIG. 11 shows an embodiment in which the conical magnet is tapered in the opposite direction.

FIG. 12 shows an embodiment similar to that of FIG. 11, with a larger diameter bottom magnet.

FIG. 13 shows an embodiment including a bucking magnet and a low reluctance return path.

FIG. 14 shows an embodiment utilizing conical magnets of both tapers, and the use of flat magnet segments to approximate a conical overall magnet structure.

FIG. 15 shows an exploded view of FIG. 14, illustrating that the conical magnet can in some applications be implemented as a series of flat magnets.

FIG. 16 shows a push-pull embodiment.

FIG. 17 shows another reverse taper conical magnet or “flower pot” embodiment.

FIG. 18 shows an embodiment suitable for placement either in front of or behind the diaphragm.

FIG. 19 shows an embodiment with a pair of very slightly conical, nearly flat magnets.

FIG. 20 shows one embodiment of a magnet charging apparatus adapted for charging a post-assembly transducer motor structure having a conical magnet.

FIG. 21 shows an embodiment specifically for use as a tweeter.

FIGS. 22 and 23 show an elliptical embodiment, such as for use with a 6×9 loudspeaker.

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

The term “semi-radially-charged” or “SRC” will be used in this disclosure to indicate that a magnet is charged in a direction that is at an angle between 0° (flat or, in other words, parallel with the axis of the motor) and 90° (radial or, in other words, perpendicular to the axis of the motor). In some instances, a semi-radially charged magnet may be charged exactly perpendicular or normal to its flux emitting surfaces, while in other instances it may be charged at a somewhat oblique angle with respect to those surfaces.

The term “conical” is not intended to be limited to a mathematically strict definition of “cone”, but is intended to refer to shapes which are between “flat” and “cylindrical”. Furthermore, “conical” is not intended to mean that the component is an axisymmetrical revolve, nor even that it is a single, contiguous part, and therefore may in fact be made up of a number of flat segments.

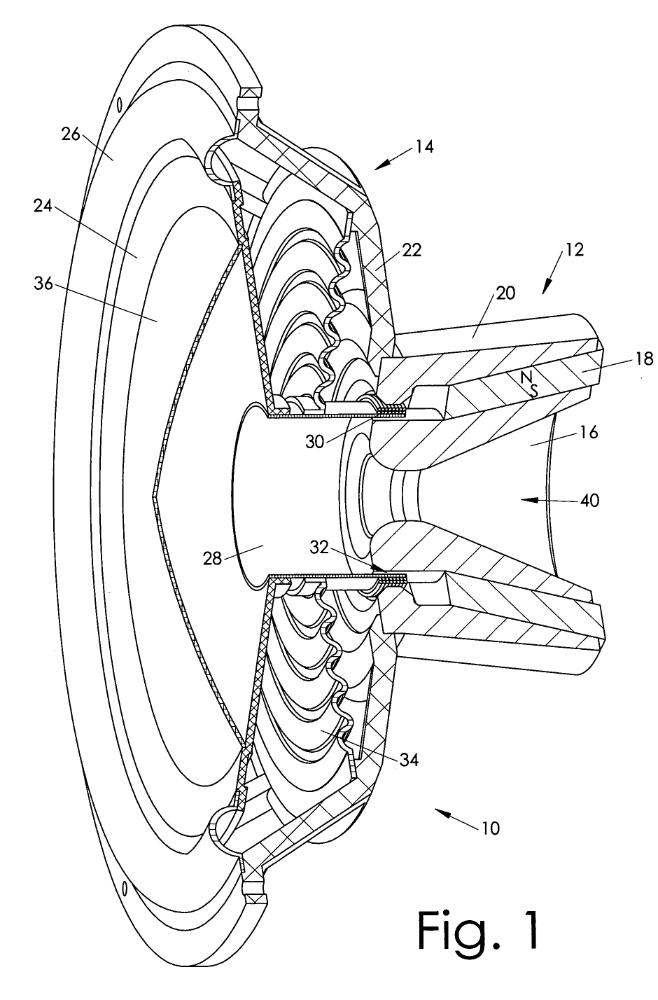

FIG. 1 illustrates an electromagnetic transducer 10 according to one embodiment of this invention, and is shown in perspective view with a cutaway which cross-sections the various components of the transducer. The transducer includes a motor structure 12 coupled to a diaphragm assembly 14.

The motor structure includes an inner yoke 16 and an outer yoke 20 which sandwich an SRC conical magnet 18. The magnet is semi-radially-charged, meaning that the inner surface of the magnet that is in contact with the inner yoke is polarized e.g. north, and the surface that is in contact with the outer yoke is oppositely polarized e.g. south.

The diaphragm assembly includes a frame 22, a diaphragm 24 coupled to the frame by a surround 26, a bobbin 28 coupled to the diaphragm, and a voice coil 30 coupled to the bobbin and suspended within a magnetic air gap 32 of the motor structure. A spider 34 suspends the bobbin from the frame, and a dust cap 36 seals the front side of the diaphragm assembly from the back side of the diaphragm assembly.

Optionally, the inner pole includes an axial vent 40 which depressurizes the air volume within the bobbin and behind the dust cap. In some embodiments, the loudspeaker is configured and mounted such that the front side of the diaphragm assembly is exposed to the listening air space. In other embodiments, the loudspeaker is configured and mounted for use as a horn or compression driver, in which case the axial vent is exposed to the listening air space.

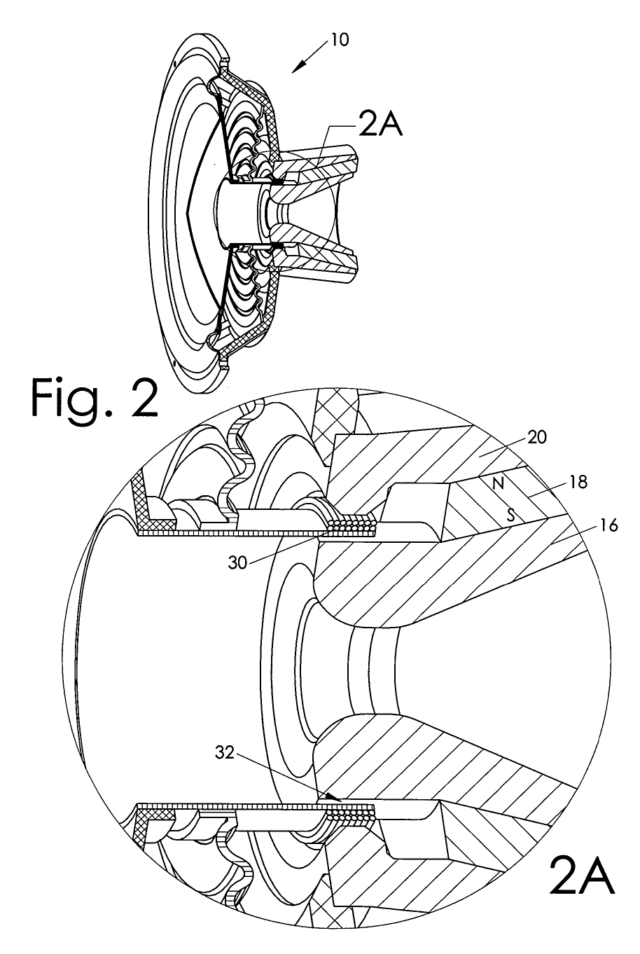

FIG. 2 with detail view 2A illustrate in closer detail the key elements of the motor structure of the transducer 10, including the inner yoke 16, the SRC conical magnet 18, the outer yoke 20, the voice coil 30, and the magnetic air gap 32.

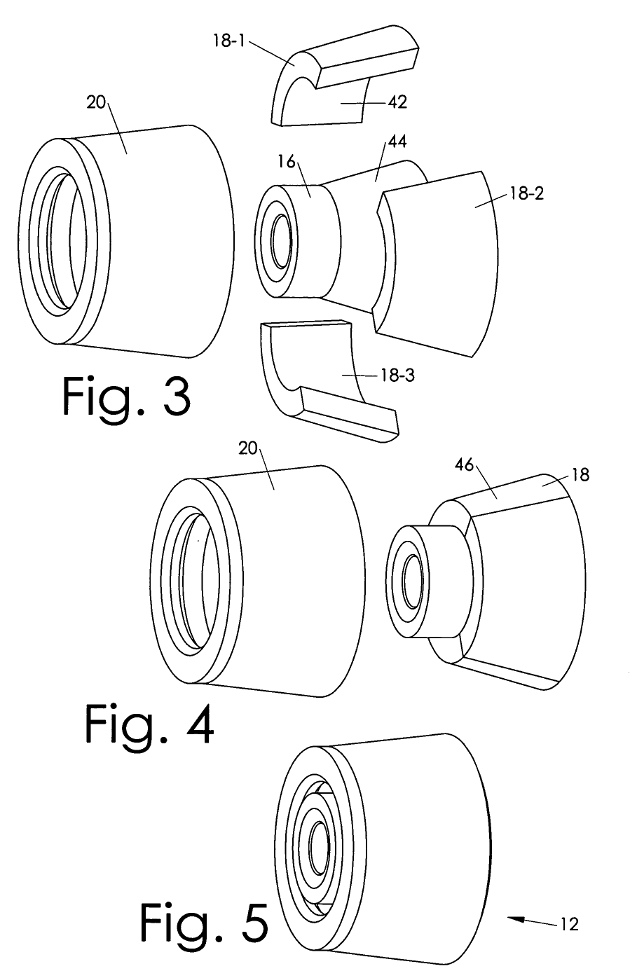

FIGS. 3-5 illustrate steps in the assembly of the motor structure 12. The inner yoke 16 includes a conically shaped outer surface 44, and the SRC conical magnet 18 includes a corresponding conically shaped inner surface 42 which mates with the outer surface of the inner yoke. In one embodiment, the magnet is comprised of a plurality of SRC magnets such as 18-1, 18-2, 18-3. The magnet includes a conically shaped outer surface 46, and the outer yoke 20 includes a corresponding conically shaped inner surface (not visible) which mates with the outer surface of the magnet.

To assemble the motor structure, the magnet segments are magnetically coupled to the conical outer surface of the inner yoke, and then this sub-assembly is inserted axially into the outer yoke until the magnet contacts the outer yoke.

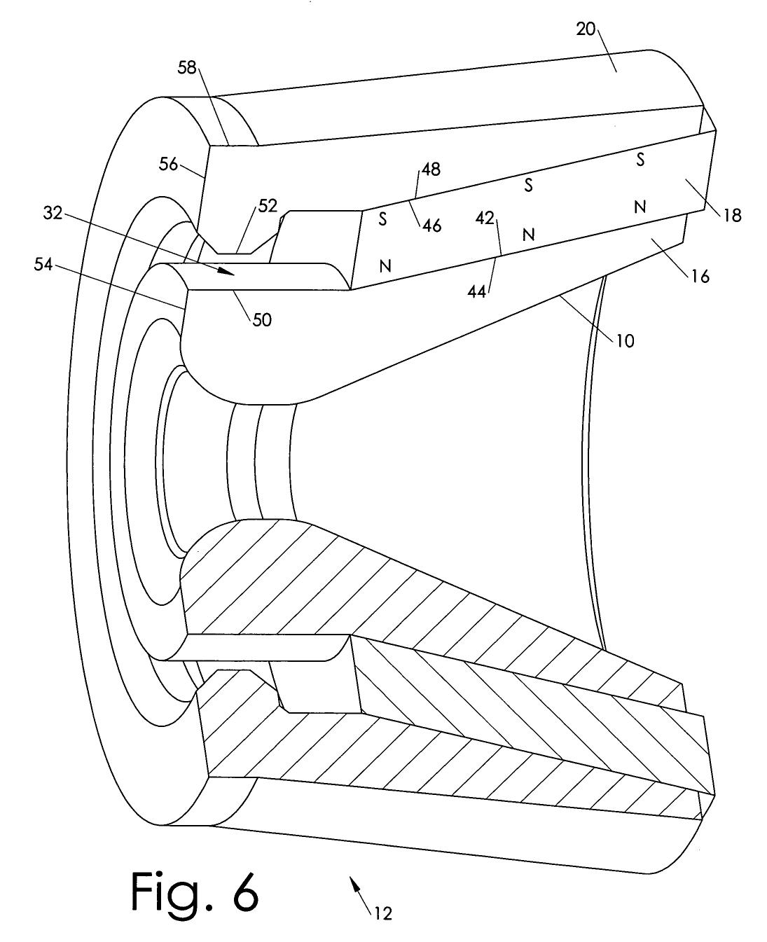

FIG. 6 illustrates the motor structure 12 in still greater detail. For ease of illustration, only the lower half of the motor structure (as shown) has been cross-hatched. The inner yoke 16 has an outer surface 44 which mates with an inner surface 42 of the magnet 18, and the magnet has an outer surface 46 which mates with an inner surface 48 of the outer yoke 20.

In some embodiments, such as that shown, the inner and outer surfaces of the magnet are parallel, meaning that the magnet has a uniform thickness over its axial length. In other embodiments, these surfaces are not parallel, and the thickness of the magnet varies over its length.

One advantage of the conical shape is that it greatly reduces, or even eliminates, the importance of exactly reproducible axial alignment of the components. The magnet segments can be magnetically coupled to the inner yoke, and this assembly is then simply inserted into the outer yoke until it “bottoms” when the magnet segments contact the outer yoke. The inner yoke and outer yoke will have very good coaxial alignment, regardless of minor unit-to-unit variations in the components' dimensions. If a particular outer yoke has a slightly tighter inner diameter of its conical portion (or if the conical magnet has a slightly larger outer diameter), it simply won't slip as far onto the inner yoke assembly before bottoming on the outer surface of the magnet segments.

Another advantage is that variation in the thickness of the magnet will not affect the concentricity of the motor alignment, unless there are differences between the thicknesses of the segments that make up the magnet. Using current manufacturing techniques, magnets tend to have greater variations in their tolerances than do the steel components.

As long as the magnetic air gap is defined by the outer yoke, and the outer yoke is the component to which the basket attaches, the magnetic air gap will be correctly aligned with respect to the voice coil, regardless of any axial variations in the positioning of the magnet and/or inner yoke.

The inner yoke includes a pole piece section 50 which forms the magnetic air gap with a gap section 52 of the outer yoke. The pole piece section can easily be made slightly extra long in the axial direction, to accommodate a variety of slightly different outer yokes or magnet thicknesses. The upper end 54 of the pole piece section and the upper end 56 of the outer yoke do not necessarily need to be aligned, nor do the lower ends. The outer surface of the outer yoke may include a section 58 sized to mate with the diaphragm assembly's frame (not shown) so as to provide good coaxial alignment of the motor structure with the voice coil (not shown).

In some embodiments, the conical magnet segments are charged in a precisely radial manner with respect to the axis of the motor structure. In other embodiments, the conical magnet segments are charged in a manner normal to the inner or outer surfaces of the magnet segments. Other variations are possible within the bounds of this invention, such as may be dictated by the abilities of the particular charging apparatus which is available for use. In some embodiments, it may not be possible to give a truly radial charge, meaning one in which the magnetic flux lines are substantially radial at all radial positions or all axial positions. In that case, it may be desirable to use an increased number of magnet segments, to better approximate a radial charge in the overall magnet.

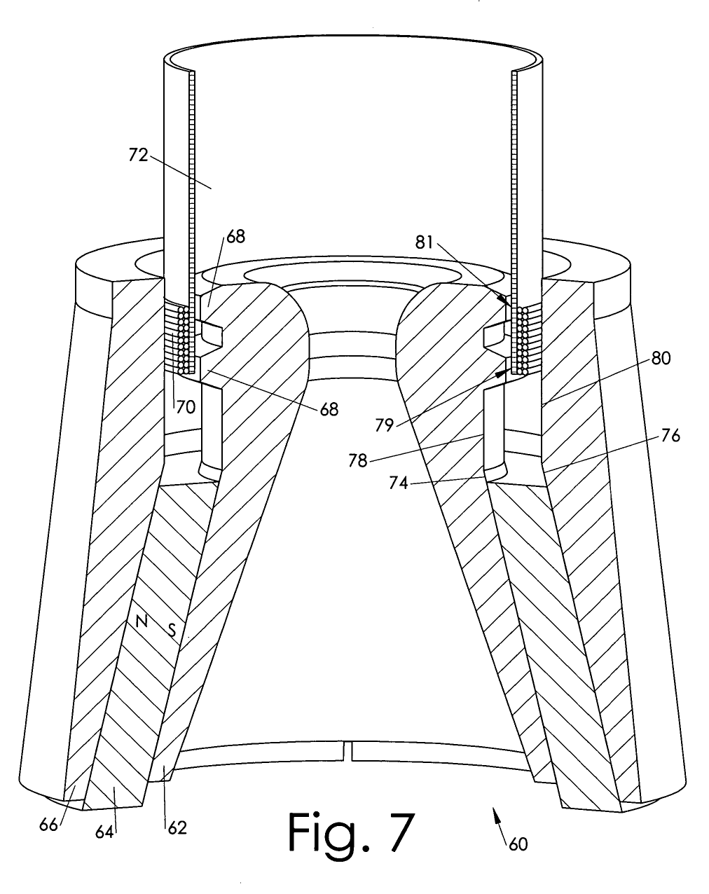

FIG. 7 illustrates a motor structure 60 according to another embodiment of this invention. In this embodiment, the diameter of the voice coil 70 and bobbin 72 is increased without increasing the relative size of the magnet 64, by putting the protruding gap sections 68 on the inner yoke 62 rather than on the outer yoke 66.

The figure also illustrates that the conical configuration is forgiving of manufacturing tolerances. The inner diameter of the magnet is slightly loose, meaning that the magnet segments sit slightly farther down (in the orientation shown) the inner yoke than in the previously illustrated embodiments, leaving a portion 74 of the conical outer surface of the inner yoke exposed. The inner diameter of the outer yoke is slightly tight, meaning that the inner yoke and magnet assembly itself sits farther down, leaving a portion 76 of the inner surface of the outer yoke exposed.

The figure further illustrates that the SRC conical magnet configuration can also be used in conjunction with a dual gap geometry, such as that taught in co-pending application Ser. No. 10/289,109 “Push-Push Multiple Magnetic Air Gap Transducer” filed Nov. 5, 2002 by this inventor. The magnetic flux travels in the same direction, e.g. generally radially outward, over both magnetic air gaps 79, 81. The voice coil extends from the middle of one gap to the middle of the other gap. This provides an extremely long geometric Xmax for a given voice coil length, and a neck portion 78 of the inner yoke and a neck portion 80 of the outer yoke may advantageously be made much shorter than would be required by a conventional overhung voice coil of equivalent Xmax, while still providing adequate clearance between the bottom of the lower magnetic air gap 79 and the top of the magnet, to prevent the voice coil assembly from bottoming against the magnet.

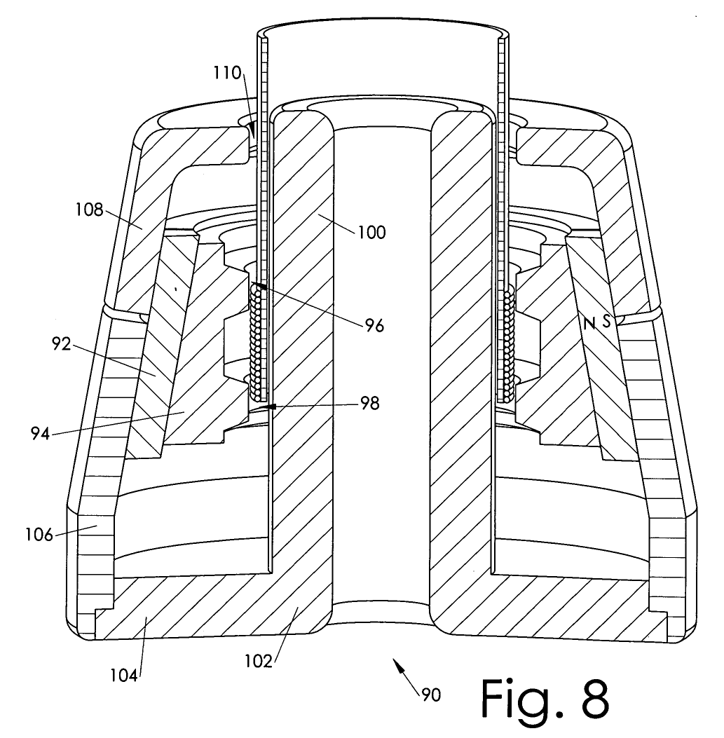

FIG. 8 illustrates a motor structure 90 according to another embodiment of this invention, utilizing a low reluctance return path such as taught in co-pending application Ser. No. 10/289,080 “Electromagnetic Transducer Having a Low Reluctance Return Path” filed Nov. 5, 2002 by this inventor. The motor structure includes an SRC conical magnet 92 mated with a drive gap yoke 94 which defines one or more drive magnetic air gaps 96, 98 with a pole piece 100 of a pole plate 102. The magnetic flux travels in a same direction over all of the drive magnetic air gaps defined by the drive gap yoke.

The pole plate further includes a back plate 104 which is coupled to a lower outer yoke 106 which is magnetically coupled to the outer surface of the conical magnet. An upper outer yoke 108 is also coupled to the outer surface of the conical magnet, and defines a low reluctance return path air gap 110 with the pole piece. Magnetic flux flows over the low reluctance return path air gap in a direction opposite that of the drive gap(s). Some of the magnetic flux flowing over the drive gap(s) will travel through the pole piece, back plate, and lower outer yoke to return to the magnet, but some will travel up the pole piece, over the return path gap, and through the upper outer yoke to return to the magnet.

Some magnetic flux may also flow from one of the outer yokes to the other, before returning to the magnet, depending upon their respective geometries and the strength of the magnet.

A voice coil is disposed within the drive gap(s). When the voice coil assembly extends far enough that the voice coil begins to enter the low reluctance return path air gap, electromagnetic braking will occur in most cases (depending upon the geometries of the components and the phase and frequency of the voice coil signal).

To assemble the motor structure, the drive gap yoke is inserted into the SRC conical magnet until it bottoms. Or, if the magnet is segmented, the segments are mated with the conical outer surface of the drive gap yoke. This assembly is then inserted into the lower outer yoke until the conical outer surface of the magnet bottoms against the conical inner surface of the lower outer yoke. This assembly is then inserted into the upper outer yoke until the conical outer surface of the magnet bottoms against the conical inner surface of the upper outer yoke. Finally, the pole plate is mated with the bottom of the lower outer yoke. The pole plate and lower outer yoke may have mating surfaces shaped to provide positive coaxial alignment and correct relative axial positioning. The pole piece may be made slightly long, to accommodate variations in manufacturing tolerances of the various conical components.

Advantageously, the various components may be affixed to each other with an adhesive, to prevent axial displacement.

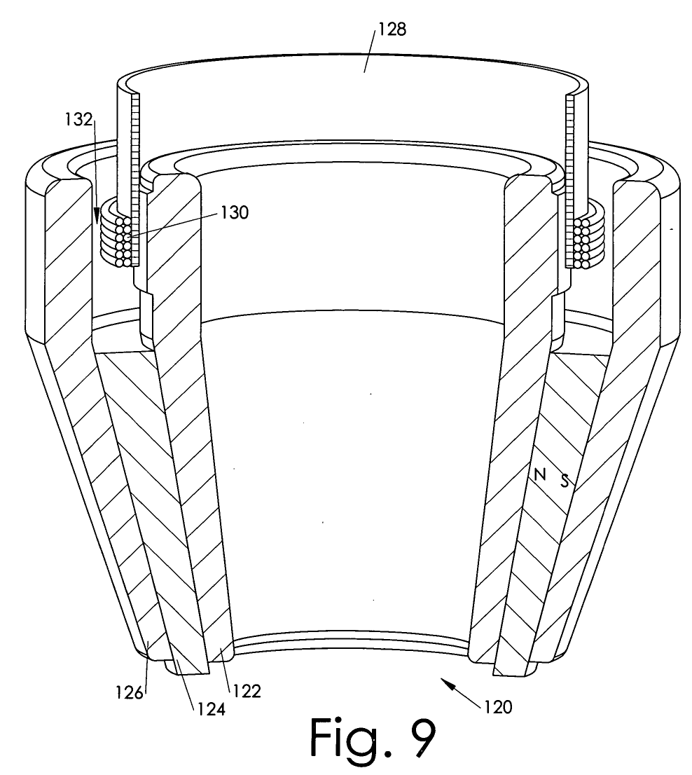

FIG. 9 illustrates a motor structure 120 according to yet another embodiment of this invention. The motor structure includes a conical inner yoke 122, an SRC conical magnet 124, and a conical outer yoke 126, all of which have an inverted conical shape versus those of the previously described embodiments. The conical magnet has a larger diameter at the upper end of the motor structure than at the lower end of the motor structure. A bobbin 128 is coupled to an underhung voice coil 130 which is disposed within a magnetic air gap 132 defined between the inner and outer yokes.

The figure also illustrates that the inner and outer surfaces of the conical magnet do not necessarily have to be parallel. In the embodiment shown, the magnet's thickness is tapered downward, such that the magnet is thinner near its bottom than near its top.

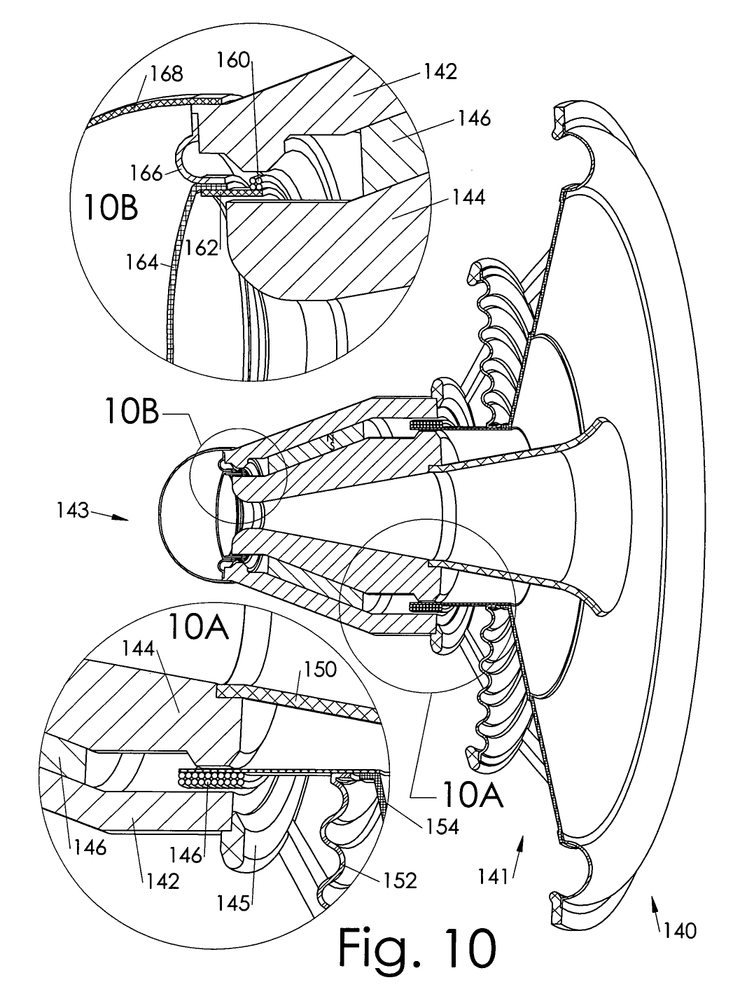

FIG. 10 illustrates an electromagnetic transducer 140 having a conical magnet double-ended motor structure. In this configuration, the transducer includes both a woofer 141 and, coaxial with it, a horn-loaded tweeter 143.

Detail view 10A illustrates the drive components of the woofer. The transducer includes an outer yoke 142 to which the woofer's frame 145 is coupled. An SRC conical magnet 146 is magnetically coupled to the inner conical surface of the outer yoke. An inner yoke 144 is magnetically coupled to the inner conical surface of the magnet, and defines a magnetic air gap with the outer yoke. The voice coil 146 of the woofer is disposed within this magnetic air gap.

Detail view 10B illustrates the drive components of the horn-loaded tweeter driver. The inner and outer yokes define a magnetic air gap (whose flux is in the same direction as that of the woofer), within which the tweeter's voice coil 160 is disposed. The tweeter's voice coil is coupled to a bobbin 162 which is coupled to (or integrally formed with) the tweeter diaphragm 164. The tweeter diaphragm is coupled to the outer yoke, which serves as the tweeter's frame, by a surround 166.

The concave side of the tweeter's diaphragm projects the sound into the listening space. A cap 168 encloses the tweeter assembly to acoustically isolate it from the back-wave pressure produced by the woofer diaphragm. This enclosed volume may be lined with or include a sound-absorbing material (not shown). The inner surface of the inner yoke functions as the initial portion of a horn for the tweeter. This horn may optionally be extended by a horn extension piece 150 shown in Detail view 10A.

Gap flux modulation generated by the interaction between the two magnetic air gaps sharing the same motor structure can be minimized by simply driving the steel of the inner and/or outer yokes into magnetic saturation by using an adequate amount of permanent magnetic material.

The horn-loaded feature can be used in other embodiments which are not dual-driver or coaxial.

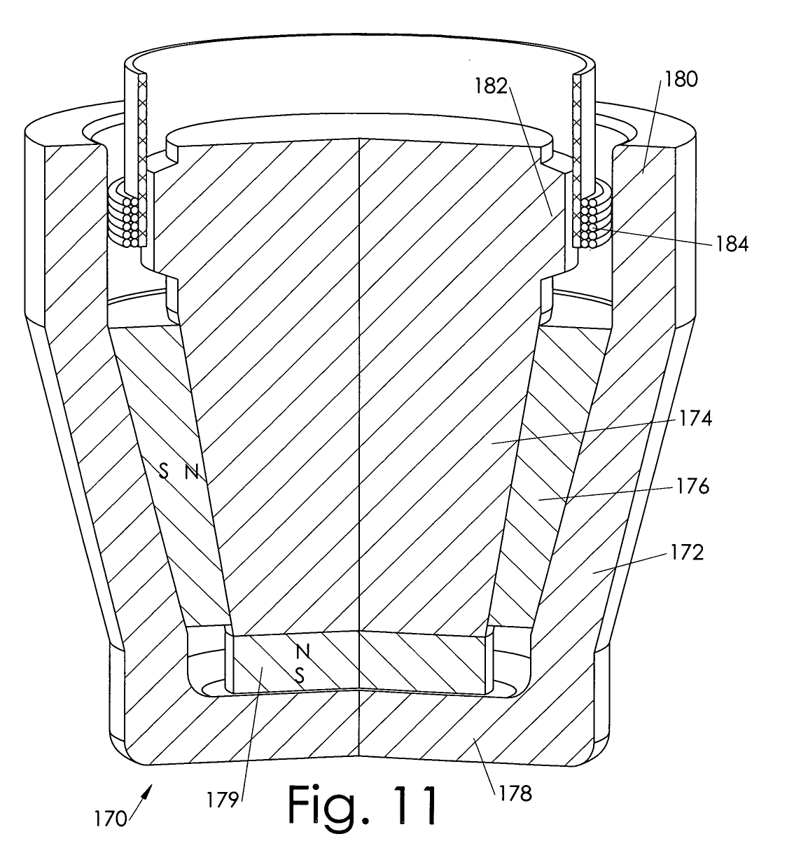

FIG. 11 illustrates a portion of a transducer 170 which does not rely solely on a conical magnet. The transducer includes an outer yoke 172 which has a conical inner surface, an SRC conical magnet 176 whose outer surface mates with the inner surface of the outer yoke, and an inner yoke 174 having a conical outer surface which mates with a conical inner surface of the magnet. The magnet is not necessarily the same thickness over its entire length; in the embodiment illustrated, the magnet is thicker at its upper end than at its lower end.

A back plate 178 is integrally formed with (or coupled to) the outer yoke. A conventional, axially-charged flat magnet 179 is magnetically coupled between the bottom of the inner yoke and the top of the back plate. The conical magnet and the flat magnet are charged such that both provide magnetic flux into, or both provide magnetic flux out of, the inner yoke. In other words, if the conical magnet is charged with its north pole inward, the flat magnet is charged with its north pole upward.

The inner yoke includes a portion 182 which defines a magnetic air gap with a cylindrical portion 180 of the outer yoke. A voice coil 184 is disposed in this magnetic air gap.

In some embodiments, a magnet may be flat on one side and curved on the other, with the corresponding yoke having flat portions and the other having a conical surface.

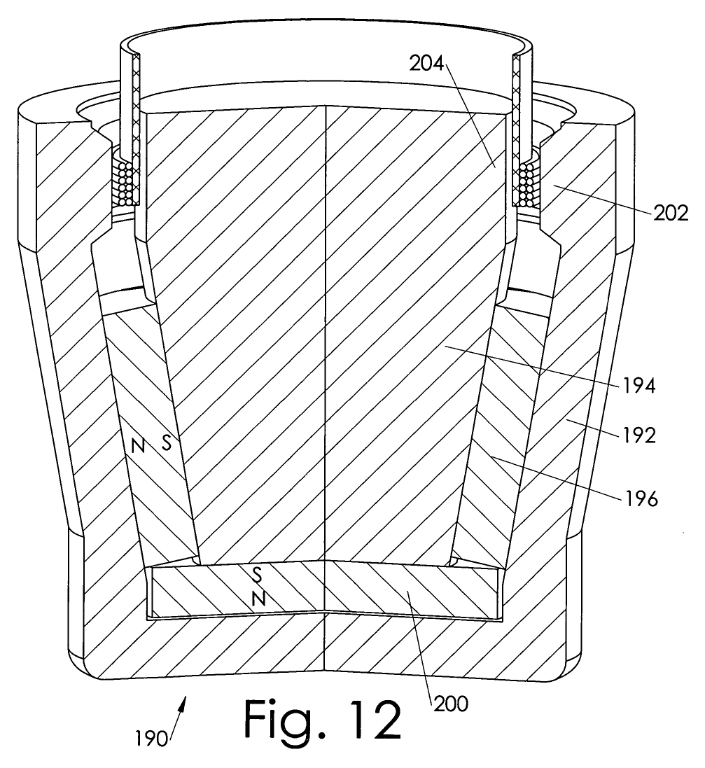

FIG. 12 illustrates a similar transducer 190, including an outer yoke 192, an inner yoke 194, and an SRC conical magnet 196. A flat magnet 200 has an increased outer diameter (with respect to that shown in FIG. 11), such that it extends radially beyond the inner diameter of the lower end of the conical magnet in order to minimize flux leakage.

The inner yoke includes a cylindrical portion 204, and the outer yoke includes a portion 202 which determines the location of the magnetic air gap. Manufacturing tolerance variations in any of the inner diameter of the outer yoke, the outer or inner diameters of the conical magnet, or the outer diameter of the inner yoke, will cause variations in the axial position (or height) of the inner yoke with respect to the outer yoke.

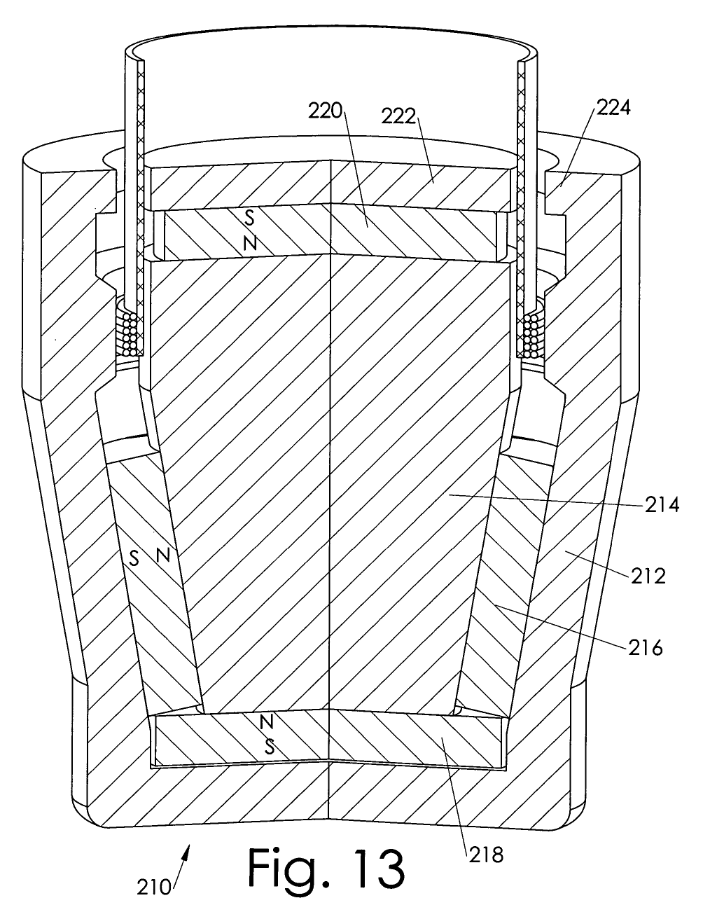

FIG. 13 illustrates a transducer 210 including an outer yoke 212, an inner yoke 214, an SRC conical magnet 216, and a lower flat magnet 218 similar to those shown in FIG. 12. The transducer further includes an upper flat magnet 220 which also provides magnetic flux into (or out of) the inner yoke (and thus is charged in the opposite direction as the lower flat magnet). A top plate 222 is magnetically coupled to the upper flat magnet, and defines a low reluctance return path with a portion 224 of the outer yoke. This gap is not used for driving the voice coil, but serves to increase the magnetic flux over the drive gap where the voice coil is located. Alternatively, a second voice coil could be added in this low reluctance return path, and used in a push-pull fashion, (or in a push-push dual-gap fashion if the polarity of the upper magnet 220 were reversed).

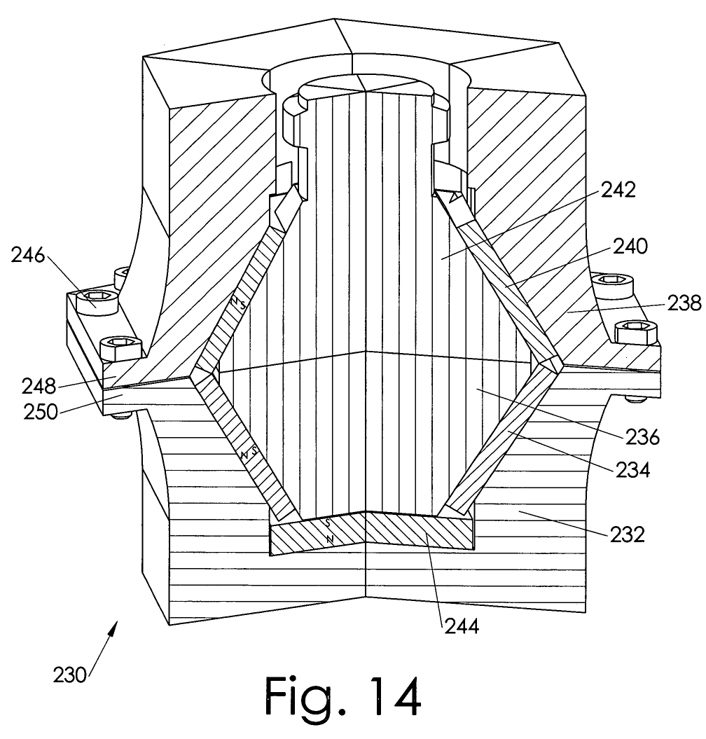

FIG. 14 illustrates a double-conical transducer motor structure 230 according to yet another embodiment of this invention. The motor structure includes a lower outer yoke 232, a lower SRC conical magnet 234, and a lower inner yoke 236. The motor structure further includes an upper outer yoke 238, an upper SRC conical magnet 240, and an upper inner yoke 242. Optionally, it may also include a bottom magnet 244. The upper and lower inner yokes may be constructed as a single unit, or separate units as shown. Any of the yokes may be segmented, as shown, or constructed as an monolithic unit.

The bottom magnet and lower conical magnet are inserted into the bottom outer yoke, the upper conical magnet is inserted into the upper outer yoke, the inner yoke is inserted into the lower yoke and magnet assembly, and the upper yoke and magnet assembly is placed over the inner yoke. The entire motor assembly is held together by bolts 246 which extend through a flange 248 of the upper outer yoke and engage with threads in a flange 250 of the lower outer yoke.

Embodiments which have stackups of conical magnets are especially sensitive to manufacturing tolerances. If manufacturing tolerances are such that it is difficult to achieve an acceptably small gap between the upper and lower outer yokes where they meet, steel shim stock can be used to reduce the magnetic reluctance of this portion of the magnetic circuit, by filling in the space between the mating surfaces of the upper and lower outer yokes.

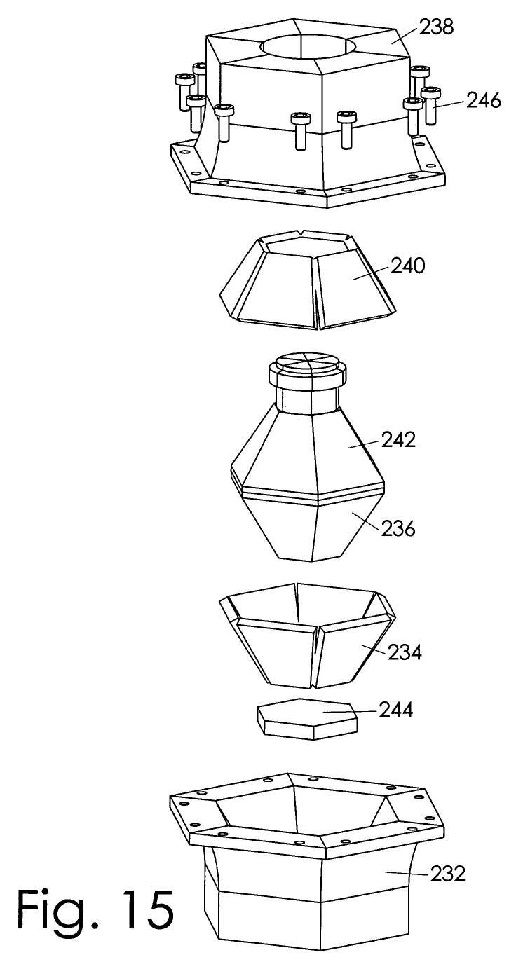

FIG. 15 is an exploded view of the motor structure of FIG. 14, and illustrates that the effect of conical magnets can be achieved with a conglomerate of flat magnets, with corresponding flat mating surfaces provided on the inner yoke and the outer yokes. In such embodiments, the flat magnets may be charged by conventional means, such that their magnetic flux is substantially normal to the large mating surfaces of the magnets.

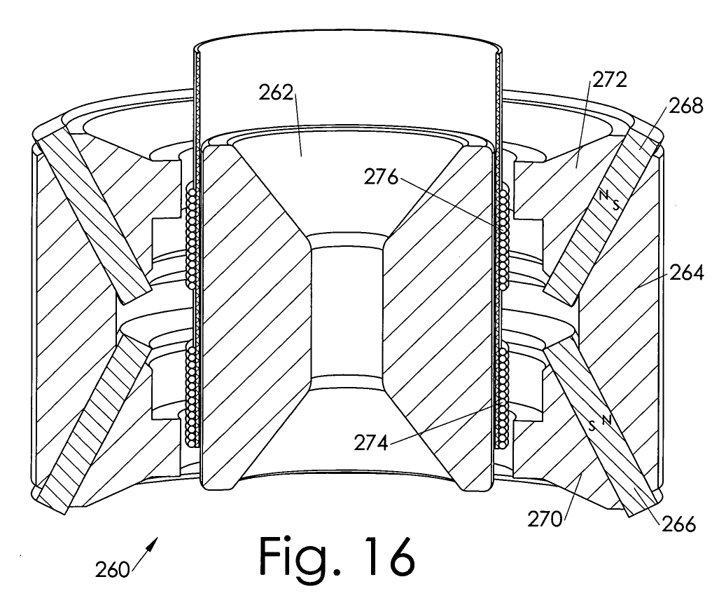

FIG. 16 illustrates an embodiment of a push-pull motor structure 260. A pole piece 262 is supported by conventional means (not shown) such as an aluminum carrier. An outer yoke 264 is provided with a pair of conical surfaces which may, in some embodiments, be mirror images of each other. To these conical surfaces are mated a pair of SRC conical magnets 266, 268. A lower gap yoke 270 is mated to a inner surface of the lower magnet, and an upper gap yoke 272 is mated to an inner surface of the upper magnet. Each of the gap yokes defines a respective magnetic air gap with the pole piece. A lower voice coil 274 is disposed within the lower magnetic air gap, and an upper voice coil 276 is disposed within the upper magnetic air gap. In one embodiment, the lower voice coil extends from the middle of the lower magnetic air gap upward, and the upper voice coil extends from the middle of the upper magnetic air gap downward, such that as the voice coil assembly moves, a constant BL is maintained although it is handed off from one gap to the other.

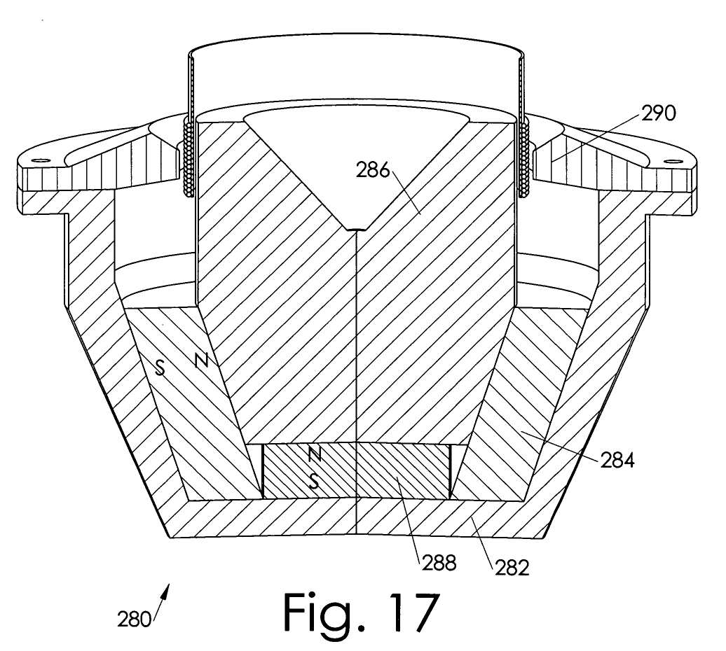

FIG. 17 illustrates a motor structure 280 similar to those of FIGS. 11 and 12. The motor includes an outer yoke 282, an SRC conical magnet 284, an inner yoke 286, an optional bottom magnet 288, and a top plate 290. The top plate may be monolithically constructed with the rest of the outer yoke, or, especially if a non-segmented magnet is used, it may be a separate component coupled to the outer yoke.

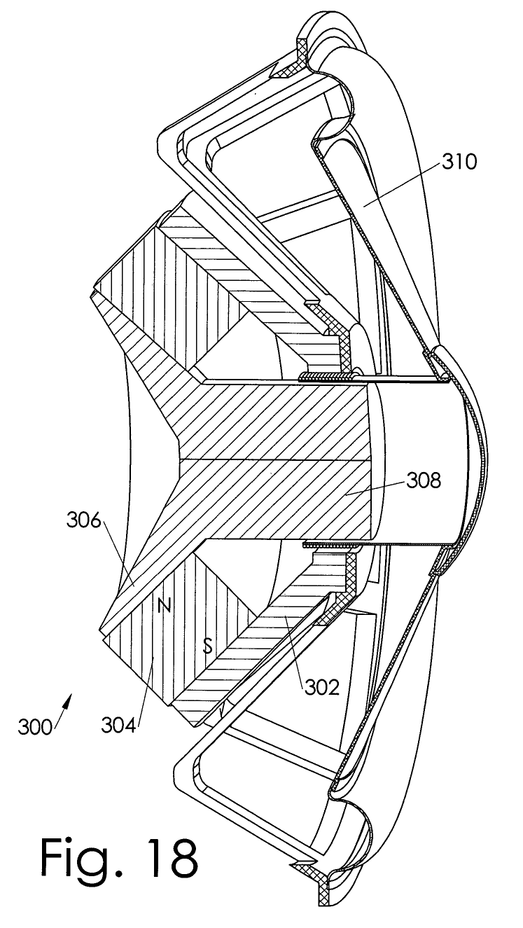

FIG. 18 illustrates an electromagnetic transducer 300 having a motor structure with some interesting advantages. The motor structure is especially suitable for use in applications in where there is the need for a front-mounted motor using thick magnets (e.g. ceramic ferrite magnets). It is also conducive for use in low-cost motors having ferrite magnets and stamped top plates. It is well suited for use in applications in which the motor is mounted in front of a conventional, concave diaphragm (not shown), or in which the motor is mounted behind an inverted, convex diaphragm 310, because the motor shape allows for a more uniform cone excursion clearance, resulting in a more compact transducer.

The motor includes a an outer yoke 302 which is angled outward and downward, as shown. In some embodiments, the angle of the outer yoke may substantially match the angle of the diaphragm. An SRC conical magnet 304 is magnetically coupled to the under side of the outer yoke, and an inner yoke 306 is magnetically coupled to the under side of the magnet. The inner yoke includes a pole piece 308 which extends upward sufficiently far to form a magnetic air gap with the inner diameter of the outer yoke.

In motors which have steep angles (closer to cylindrical than flat), it may in some applications be acceptable to give the magnet a truly radial charge. This will reduce the amount of flux generated in the magnetic circuit, versus the amount of flux that would be generated by a semi-radially-charged magnet, because the flux lines will not be perpendicular to the emitting surfaces of the magnet. However, it may be possible to compensate by e.g. using a thinner, larger diameter magnet of the same mass, and still have the same effective magnetic load characteristics.

In motors which have shallow angles (closer to flat than cylindrical), it may in some applications be acceptable to give the magnet a truly axial charge, with a similar effect.

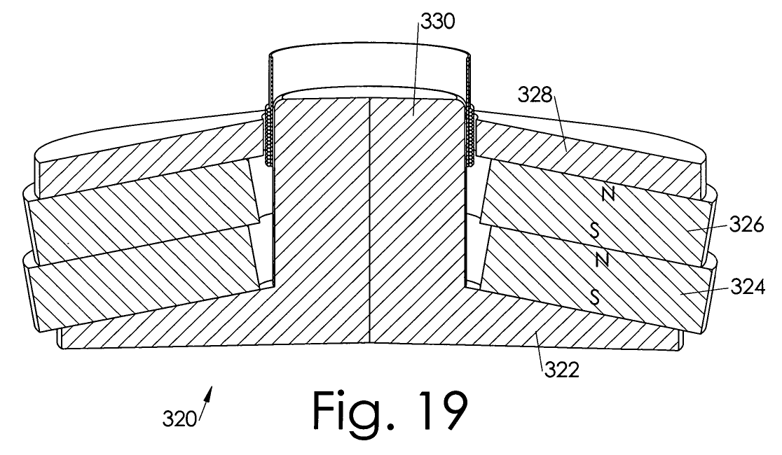

FIG. 19 illustrates a motor structure 320 having a relatively flat conical angle. The motor includes a pole plate 322 having a conical surface to which one or more conical magnets 324, 326 is magnetically coupled. A conical top plate 328 is magnetically coupled to the uppermost magnet, and defines the magnetic air gap with a pole piece 330 of the pole plate.

In order to provide the maximum amount of magnetic flux, it will generally be the case that the magnet should be charged substantially perpendicular to its surfaces which will mate with other, serial components in the magnetic circuit of the motor structure. In embodiments using a very shallow conical angle, this semi-radial charge may be closer to an axial orientation than to a strictly radial orientation with respect to the axis of the motor.

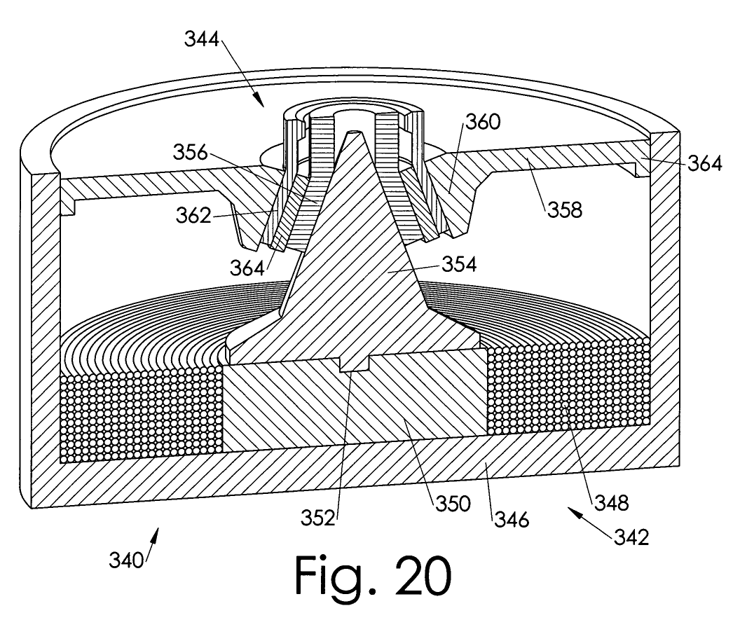

FIG. 20 illustrates a magnet charging system 340 which may be used in radially charging conical magnets for use in practicing the present invention, and is especially useful in post-motor-assembly charging. The system includes a charging apparatus 342, into which is loaded an assembled transducer motor structure 344.

The charging apparatus includes a magnetically conductive outer charger housing 346 which houses a powerful electromagnet including a coil 348 surrounding a magnetically conductive core 350. The core is adapted with a centering fixture 352 for holding a replaceable magnetically conductive conical mating element 354 in a correct radial position. The outer surface of the conical mating element is provided with an angle selected to mate with an angle of the inner yoke 356 of the motor being charged. The same charging system can be used with a variety of motor configurations, by swapping different conical mating elements.

The motor structure is placed onto the conical mating element, and a magnetically conductive charger lid 358 is lowered onto the motor structure until a conical inner portion 360 of the lid mates with the outer yoke 362 of the motor structure. The lid includes a cylindrical outer perimeter 364 which mates with the inner surface of the housing, completing the magnetic circuit.

When the charging coil is activated, a very large amount of magnetic flux is generated into the charger core, from which it travels through the conical mating element, and then through the motor structure's inner yoke. The majority of the magnetic flux will then travel through the conical magnet in a direction substantially perpendicular to the outer conical surface of the inner yoke and into the outer yoke. A smaller amount of flux will harmlessly jump the motor's magnetic air gap. The flux will continue through the motor's outer yoke, outward through the charger lid, down through the housing, and back to the charging coil. The magnet will be permanently charged, the lid is removed, and another motor can be inserted for charging.

In the case of embodiments which use a group of flat magnets to approximate a conical magnet, a conventional charging system may be used, or the system of FIG. 20 can be used, as the manufacturer sees fit.

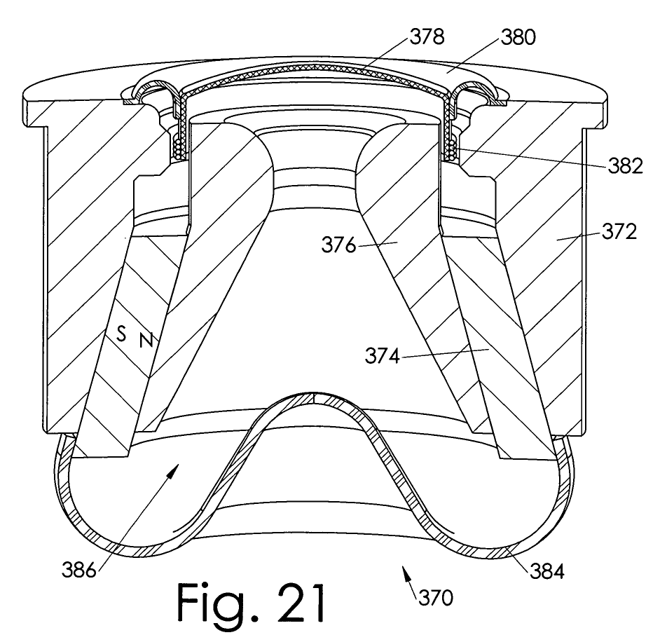

FIG. 21 illustrates a tweeter 370 according to another embodiment of this invention. The tweeter includes an outer yoke 372, an SRC conical magnet 374, and an inner yoke 376. A diaphragm or dome 378 is coupled to the outer yoke by a surround 380. A voice coil 382 is disposed within the magnetic air gap between the inner and outer yokes. In the embodiment shown, the voice coil is wound directly onto a cylindrical portion of the diaphragm. In other embodiments, the voice coil is wound onto a bobbin (not shown) which is coupled to the diaphragm. The conical shape of the motor provides a large air volume 386 behind the diaphragm. Optionally, this air volume can be sealed by a cap 384.

Sealing the back surface of the diaphragm from the rear ambient (on the opposite side of the cap) enables the tweeter to be used in a multi-transducer cabinet without requiring the cabinet to be sectioned into separate air volumes (in order to prevent cabinet pressure from the other transducers from affecting operation of the tweeter). Optionally, the cap may be made of e.g. plastic, enabling it to be snapped into position over the flared rear end of the magnet (or other structures) without requiring additional mounting means. The domed shape of the cap increases its rigidity, improving its ability to resist deformation caused by pressurization of the air volumes on either side of it. Alternatively, the outer yoke could be cup-shaped and self-sealing, and no cap would be needed. Conventional neo disc tweeters have very small enclosed air volumes, due to the shapes of their motors. This raises their resonant frequency, and thereby restricts their ability to reproduce low-frequency sounds.

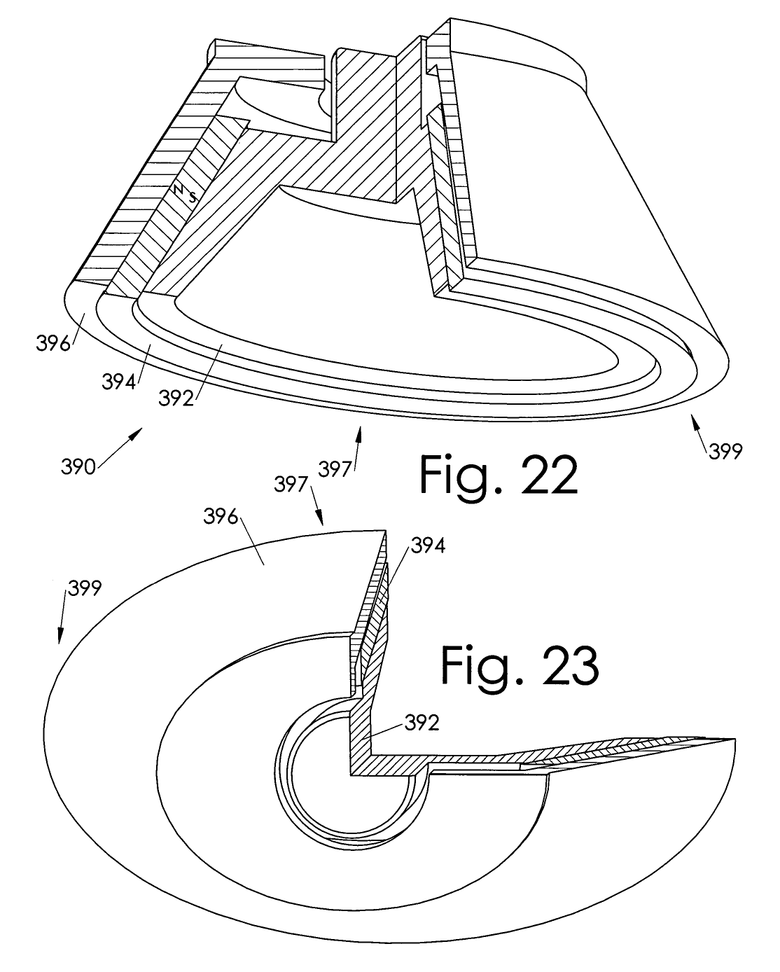

FIGS. 22 and 23 illustrate a motor structure 390 which includes an elliptically shaped inner yoke 392, an elliptically-conical SRC magnet 394, and an elliptically shaped outer yoke 396. The elliptically shaped motor includes a narrow portion 397 and a wide portion 399. This motor is especially suitable for use with elliptical or other elongated transducers, for example a 6×9 car audio speaker.

### CONCLUSION

In some embodiments, the present invention may be practiced using conical magnets having a conical angle between 1° and 15° (where 0° is a conventional, flat magnet, and 90° is a conventional—though quite rare—cylindrical magnet). In other embodiments, the invention may use conical magnets having a conical angle between 15° and 30°. In still other embodiments, the invention may use conical magnets having a conical angle between 30° and 45°. In still other embodiments, the invention may use conical magnets having a conical angle between 45° and 60°. In still other embodiments, the invention may use conical magnets having a conical angle between 60° and 75°. In still other embodiments, the invention may use conical magnets having a conical angle between 75° and 89°. Note that those angles may indicate either an upward or downward angled cone.

The term “radially-charged” does not mean that the charging direction is exactly perpendicular to the axis of the motor. Typically and most advantageously, the charging direction is perpendicular to the surface of the magnet, regardless of the conical angle of the magnet.

One significant advantage of the conical motor is that it is naturally self-aligning. By contrast, the components of a conventional flat motor can easily slip laterally with respect to each other during the assembly process, such that they are not coaxial when they become permanently coupled together (such as by glue drying or by bolts tightening).

Another significant advantage of the conical motor is that it allows a radial or semi-radial charge, and yet is not as critically sensitive to manufacturing tolerances as, for example, a cylindrical motor (which are known but, for this very reason, almost never used).

Manufacturing tolerances can, as explained above, cause axial misalignment (different relative heights) of the components which define the magnetic air gap, such as the inner and outer yokes. In general, the less flat the conical shape, the greater this effect will be, in a roughly tan(angle) relationship. Flat angles near 0° are not much affected by minor tolerance variations, and steep angles near 90° are much more affected.

Implementations which use two conical structures, for example that of FIG. 16, are doubly affected. However, the manufacturer can use the double tolerance stackup to his advantage. By sorting the duplicated component, e.g. the conical magnet, into bins according to the amount they are above or below the desired thickness, the manufacturer can free himself from the need to actually provide tight manufacturing tolerance controls. To do this, he simply selects pairs of magnets, one from e.g. the +0.5 mm bin and one from the −0.5 mm bin. Intervening components (such as the outer yoke 264 in FIG. 16) will be shifted axially, but the components outside the stackup (such as the gap yokes 270, 272 in FIG. 16) will achieve their desired relative position with respect to each other.

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer motor structure comprising:
an inner yoke having a conical outer surface;
an outer yoke having a conical inner surface; and
a conical magnet having a first surface magnetically coupled to the conical outer surface of the inner yoke, and a second surface magnetically coupled to the conical inner surface of the outer yoke.

2. The electromagnetic transducer motor structure of claim 1 wherein:
the conical magnet is semi-radially-charged.

3. The electromagnetic transducer motor structure of claim 1 wherein:
the conical magnet is radially-charged.

4. The electromagnetic transducer motor structure of claim 1 wherein:
the conical magnet is axially-charged.

5. The electromagnetic transducer motor structure of claim 1 wherein:
the conical magnet comprises a plurality of magnets.

6. The electromagnetic transducer motor structure of claim 5 wherein:
the conical outer surface of the inner yoke includes a plurality of flat surfaces which, together, approximate a conical shape;
the conical inner surface of the outer yoke includes a plurality of flat surfaces which, together, approximate a conical shape; and
each of the plurality of magnets comprises a flat magnet magnetically coupled to a respective one of the flat surfaces of the inner yoke and to a respective one of the flat surfaces of the outer yoke.

7. The electromagnetic transducer motor structure of claim 1 wherein:
the conical magnet has a conical angle between 1° and 89°.

8. The electromagnetic transducer motor structure of claim 7 wherein:
the conical magnet has a conical angle between 15° and 75°.

9. The electromagnetic transducer motor structure of claim 8 wherein:
the conical magnet has a conical angle between 30° and 60°.

10. The electromagnetic transducer motor structure of claim 9 wherein:
the conical magnet has a conical angle between 40° and 50°.

11. The electromagnetic transducer motor structure of claim 1 further comprising:
a first magnetic air gap defined between the inner and outer yokes;
a second magnetic air gap defined between the inner and outer yokes;
a first diaphragm assembly having a voice coil disposed within the first magnetic air gap; and
a second diaphragm assembly having a voice coil disposed within the second magnetic air gap.

12. The electromagnetic transducer motor structure of claim 11 wherein:
the first and second magnetic air gaps are at opposite ends of the outer yoke and are substantially coaxial.

13. The electromagnetic transducer motor structure of claim 12 wherein:
the inner yoke includes an axial opening forming a horn for the second diaphragm assembly;
wherein the first and second diaphragm assemblies generate sound in a same direction.

14. The electromagnetic transducer motor structure of claim 1 further comprising:
a diaphragm assembly including a diaphragm having a first conical orientation;
wherein the outer yoke has the first conical orientation;
whereby a motor structure of the electromagnetic transducer is disposed within a cone of the diaphragm.
